(19) United States
(12) Patent Application Publication
(10) Pub. No.: US 2026/0282115 A1
(43) Pub. Date: Sep. 17, 2026

(54) MOBILE COMMUNICATION DEVICE AND METHOD

(71) Applicant: MEDIATEK Inc., Hsinchu City (TW)

(72) Inventors: Po-Wen HSIAO, Hsinchu City (TW); Chin-Hung WANG, Hsinchu City (TW); Kuo-Ming CHEN, Hsinchu City (TW)

(21) Appl. No.: 19/683,791

(22) Filed: May 21, 2026

Related U.S. Application Data
(63) Continuation of application No. 18/656,736, filed on May 7, 2024.
(60) Provisional application No. 63/500,643, filed on May 8, 2023.

(51) Int. Cl. H04W 74/0833; H04W 84/12

(52) U.S. Cl. CPC H04W 74/085; H04W 74/0858; H04W 84/12

(57) ABSTRACT

The application discloses a mobile communication device and method. The mobile communication method includes: when a collision between third party communication by a third party module and Wi-Fi communication by a Wi-Fi module is detected, determining a next Wi-Fi receiving gain; and adjusting a Wi-Fi receiving gain based on the calculated next Wi-Fi receiving gain to concurrently receive Wi-Fi signals and third party signals.

This application is a continuation application of US Patent Application Serial No. 18/656,736 filed May 7, 2024, which claims the benefit of US provisional application Serial No. 63/500,643, filed May 8, 2023, the disclosure of which are incorporated by reference herein in its entirety.

### TECHNICAL FIELD

The disclosure relates in general to a mobile communication device and method.

### BACKGROUND

In the field of mobile communications, the term "third party" generally refers to organizations or individuals other than the communication service providers (such as telecommunications companies) and users (such as mobile phone users). These third parties may offer a variety of services or applications. In generally, the third parties are such as (1) Application Developers which provide mobile applications that may require the use of communication networks for data transmission; (2) Content Providers which offer digital content like music, videos, news, etc.; (3) Payment Service Providers which offer payment or money transfer services, often in collaboration with telecommunications companies or other financial institutions; (4) Advertising Companies which utilize mobile communication platforms to push advertisements; (5) Hardware Manufacturers which provide additional hardware and software support in addition to basic communication functions; (6) Security Service Providers which offer various security solutions, including encryption and firewall services; and (7) Data Analytics Companies which collect and analyze user data to provide more personalized services or advertisements. Third parties play a significant role in the mobile communication system. They not only enrich the choices available to users but also create new revenue streams for communication service providers.

Wi-Fi (Wireless Fidelity) is a wireless networking technology widely used in various settings and applications. Below are the main uses of Wi-Fi. (1)Home Networks: Wi-Fi is used to connect a variety of devices in homes, including computers, smartphones, tablets, and even smart home devices like smart bulbs and smart refrigerators. (2) Corporate Networks: In office and corporate environments, Wi-Fi is used to provide employees with wireless access to internal networks and the internet. (3) Public Places: Airports, coffee shops, libraries, and other public places offer free or paid Wi-Fi services to facilitate internet access for people. (4) Educational Institutions: Schools and universities typically provide campus-wide Wi-Fi to support education and research. (5) Internet of Things (IoT): Wi-Fi is also used to connect various IoT devices, ranging from smart homes to industrial applications. (6) Media and Entertainment: Wi-Fi is used for streaming music, videos, and gaming data, providing a better entertainment experience. (7) Mobility and Portability: Wi-Fi allows users to move between different locations (within a certain range) without interrupting their network connection.

Below is importance of Wi-Fi. (1) Convenience: Wi-Fi provides a quick and easy way to access the network without the need for physical connections. (2) Cost-Effectiveness: Wi-Fi reduces the need for cabling, thereby lowering the costs of network construction and maintenance. (3) Flexibility and Scalability: Wi-Fi networks are easy to expand; all that's needed is to add wireless access points. (4) Multi-Device Connectivity: Wi-Fi allows multiple devices to connect to the same network simultaneously, which is very useful in multi-device households and corporate environments. (5) Facilitating Innovation and Development: Wi-Fi technology is continually evolving, supporting higher data transfer speeds and more secure connections, which promotes the development of new applications and services. (6) Social and Economic Impact: Wi-Fi has not only changed people's lifestyles but also has a broad impact on business and the economy, including remote work, online education, and e-commerce.

In summary, Wi-Fi plays an extremely important role in modern society. It has changed the way people’s access and use information and continues to drive technological and social progress.

Mobile communication devices usually support third party signal receiving functions and Wi-Fi signal receiving/transmission functions.

However, sometimes, mobile communication devices may face the problem of collision between third party signal receiving and Wi-Fi signal receiving, which means mobile communication devices has to concurrently receive third party signal and Wi-Fi signal.

When this collision occurs, prior art will abort communication between Wi-Fi and the third party. But, there are many different risks involved when aborting communication between Wi-Fi and third party. If Wi-Fi communication is aborted, then Wi-Fi data transmission may be negatively affected, leading to data not being correctly or completely received. Also, in abortion of Wi-Fi signal receiving, there is an increased risk of PER (Packet Error Rate), which means that the rate of Wi-Fi packet errors may increase. In Wi-Fi communication, more data packets may fail to transmit, requiring retransmission, which would reduce network performance.

On the contrary, if third party signal receiving is aborted, there is a need for third party signal retransmission, which means that third party data may need to be retransmitted, consuming more time and resources. Also, there is a risk of increased latency which may affect the user experience, especially in applications that require real-time responsiveness, such as video calls or online gaming.

In summary, aborting either Wi-Fi or third party comes with its respective risks and consequences. These risks could affect system performance and user experience. Therefore, careful evaluation and consideration are needed before undertaking such operations.

Thus, the application provides a mobile communication device and method which may resolve the prior problems.

### SUMMARY

The disclosure is directed to a strategy for managing potential interference between Wi-Fi communication and third party communication based on estimates of whether Wi-Fi reception (RX) and third-party communication will occur simultaneously for adjusting Wi-Fi RX gain.

According to one embodiment, a mobile communication device is provided. The mobile communication device includes: an antenna set for receiving third party signals and Wi-Fi signals; a third party module coupled to the antenna set, for processing the third party signals received by the antenna; and a Wi-Fi module coupled to the antenna set for processing the Wi-Fi signals received by the antenna set. Wherein when a collision between third party communication by the third party module and Wi-Fi communication by the Wi-Fi module is detected, a next Wi-Fi receiving gain is determined, and the Wi-Fi module adjusts a Wi-Fi receiving gain based on the next Wi-Fi receiving gain to concurrently receive Wi-Fi signals and third party signals.

According to another embodiment, a mobile communication method is provided. The mobile communication method includes: when a collision between third party communication by a third party module and Wi-Fi communication by a Wi-Fi module is detected, determining a next Wi-Fi receiving gain; and adjusting a Wi-Fi receiving gain based on the calculated next Wi-Fi receiving gain to concurrently receive Wi-Fi signals and third party signals.

### BRIEF DESCRIPTION OF THE DRAWINGS

FIG. 1 shows a functional block diagram of a mobile communication device according to one embodiment of the application.

FIG. 2 shows a signal waveform of the mobile communication device according to one embodiment of the application.

FIG. 3A shows waveform of the prior art mobile communication and FIG. 3B shows waveform of the mobile communication according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

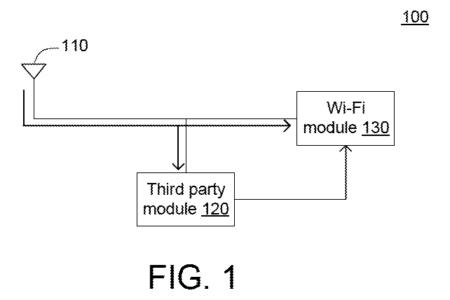

FIG. 1 shows a functional block diagram of a mobile communication device according to one embodiment of the application. The mobile communication device 100 according to one embodiment of the application includes an antenna set 110, a third party module 120 and a Wi-Fi module 130.

The antenna set 110 is coupled to the third party module 120 and the Wi-Fi module 130. The antenna set 110 is for receiving third party signals and Wi-Fi signals. The third party signals received via the antenna set 110 is sent to the third party module 120; and the Wi-Fi signals received via the antenna set 110 is sent to the Wi-Fi module 130.

The third party module 120 is for processing the received third party signals. Also, in one embodiment of the application, when the third party module 120 expects that there is any collision between third part communication and Wi-Fi communication (which means the mobile communication device 100 concurrently receives the third party signals and the Wi-Fi signals), the third party module 120 calculates the next Wi-Fi receiving gain and informs and/or controls the Wi-Fi module 130 to reduce the Wi-Fi receiving gain for preventing failure of Wi-Fi signal receiving. The third party module 120 includes a plurality of hardware circuits for performing the above processing operations. Details of the third party module 120 are described below.

The Wi-Fi module 130 is for processing the received Wi-Fi signals. Also, in one embodiment of the application, when informed/and or controlled by the third party module 120, the Wi-Fi module 130 reduces the Wi-Fi receiving gain based on the next Wi-Fi receiving gain calculated by the third party module 120 for preventing failure of Wi-Fi signal receiving. The Wi-Fi module 130 includes a plurality of hardware circuits for performing the above Wi-Fi operations.

In another embodiment of the application, when the collision between third part communication by the third party module 120 and Wi-Fi communication by the Wi-Fi module 130 is detected or expected by the Wi-Fi module 130, the Wi-Fi module 130 calculates the next Wi-Fi receiving gain. The Wi-Fi module 130 adjusts the Wi-Fi receiving gain based on the next Wi-Fi receiving gain calculated by the Wi-Fi module 130 to concurrently receive Wi-Fi signals and third party signals.

In other words, in one embodiment of the application, when a collision between third party communication by the third party module 120 and Wi-Fi communication by the Wi-Fi module 130 is detected by either the third party module 120 or the Wi-Fi module 130, a next Wi-Fi receiving gain is determined by either the third party module 120 or the Wi-Fi module 130. The Wi-Fi module adjusts a Wi-Fi receiving gain based on the next Wi-Fi receiving gain to concurrently receive Wi-Fi signals and third party signals.

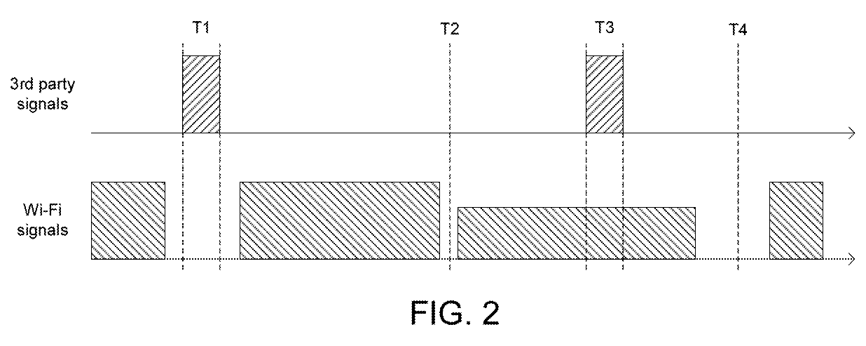

FIG. 2 shows a signal waveform of the mobile communication device according to one embodiment of the application. At timing T1, the mobile communication device 100 receives the third party signals. At timing T2, the third party module 120 expects that there will be a collision between third part communication and Wi-Fi communication (which means the mobile communication device 100 concurrently receives the third party signals and the Wi-Fi signals), the third party module 120 calculates the next Wi-Fi receiving gain and informs and/or controls the Wi-Fi module 130 to reduce the Wi-Fi receiving gain for preventing failure of Wi-Fi signal receiving. At timing T3, with the reduced Wi-Fi receiving gain, the mobile communication device 100 is capable of receiving both the third party signals and the Wi-Fi signals preventing failure of Wi-Fi signal receiving. At timing T4, the third party module 120 expects the collision between third part communication and Wi-Fi communication disappears, the third party module 120 calculates the next Wi-Fi receiving gain (which is higher) and informs and/or controls the Wi-Fi module 130 to increase the Wi-Fi receiving gain for facilitating Wi-Fi signal receiving.

The above example describes that the third party module 120 expects or determines the collision and the third party module 120 calculates the next Wi-Fi receiving gain. In other possible example, the Wi-Fi module 130 expects or determines the collision and the Wi-Fi module 130 calculates the next Wi-Fi receiving gain, which is still within the spirit and the scope of the application.

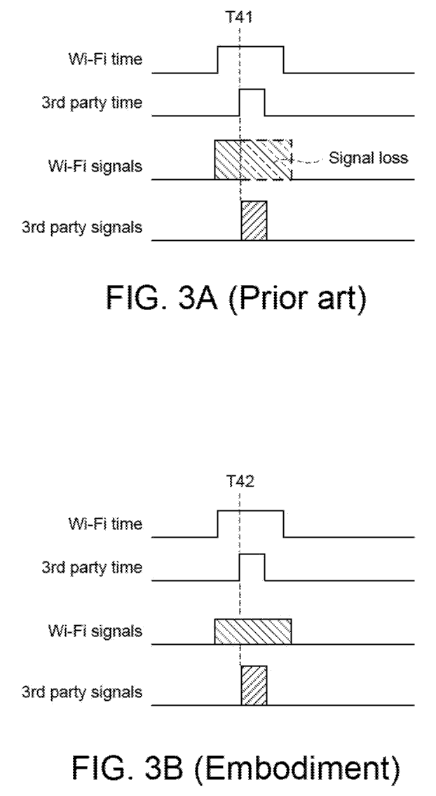

FIG. 3A shows waveform of the prior art mobile communication and FIG. 3B shows waveform of the mobile communication according to one embodiment of the application. In FIG. 3A and FIG. 3B, during the “Wi-Fi time”, the mobile communication device receives Wi-Fi signals; during the “third party time”, the mobile communication device receives third party signals; “Wi-Fi signals” refers to the Wi-Fi signals received by the mobile communication device; and “third party signals” refers to the third party signals received by the mobile communication device.

As shown in FIG. 3A, at timing T41, due to receiving third party signals, the prior art mobile communication is not able to receive the Wi-Fi signals and thus Wi-Fi signals after the timing T41 is loss.

On the contrary, As shown in FIG. 3B, at timing T42, the mobile communication device according to one embodiment of the application expects that there is collision between third part communication and Wi-Fi communication, the third party module calculates the next Wi-Fi receiving gain and informs and/or controls the Wi-Fi module 130 to reduce the Wi-Fi receiving gain for preventing failure of Wi-Fi signal receiving. Thus, at timing T42, the mobile communication device according to one embodiment of the application is capable of receiving both the third party signals and the Wi-Fi signals, without loss of Wi-Fi received signals.

One embodiment of the application discloses a strategy for managing potential interference between Wi-Fi and third party. Specifically, the strategy of one embodiment of the application is based on estimates of whether Wi-Fi reception and third-party activity will occur simultaneously. When it is estimated that Wi-Fi RX will not occur simultaneously with 3rd Party, the third party module chooses a larger Wi-Fi RX gain. This is generally to improve the quality and efficiency of data reception. On the other hand, when it is estimated that Wi-Fi reception and third-party activity will occur simultaneously, the third party module chooses a smaller Wi-Fi RX Gain. This is to minimize potential issues due to interference, such as an increase in Packet Error Rate (PER). The strategy of one embodiment of the application attempts to improve the overall communication quality and efficiency between Wi-Fi communication and third parties communication by dynamically adjusting the Wi-Fi reception gain to adapt to different communication environments. One embodiment of the application discloses a relatively flexible approach that allows for the selection of the most appropriate settings based on the actual situation.

Therefore, one embodiment of the application describes a strategy specifically aimed at communication scenarios involving Wi-Fi and third party. According to one embodiment of the application, the reception gain value of Wi-Fi can be dynamically adjusted to avoid the need to abort communication with either Wi-Fi or the third party, thereby reducing or eliminating associated risks. One embodiment of the application allows the Wi-Fi module to adjust its Wi-Fi reception Gain value based on the next Wi-Fi reception gain value calculated by the third party module in response to actual needs or environmental conditions. Through the dynamic adjustment mechanism, the mobile communication device and method of one embodiment of the application can more flexibly respond to potential interference or other issues, thereby avoiding the need to abort Wi-Fi communication or the third party communication. The mobile communication device and method of one embodiment of the application can reduce risks such as packet errors and increased latency. The mobile communication device and method of one embodiment of the application could significantly improve the stability and efficiency of communications between Wi-Fi and third parties, especially in high-interference or high-density environments. The mobile communication device and method of one embodiment of the application could also provide a better experience for communication service providers and end-users.

Also one embodiment of the application discloses a feature or mechanism called "3rd Party Real-time Interference Detect." This mechanism according to one embodiment of the application is designed specifically to address potential interference issues between Wi-Fi and third party. When the mobile communication device and method of one embodiment of the application predicts that Wi-Fi reception and third-party communication will not occur at the same time, a larger Wi-Fi receive gain is selected. This is generally to improve the quality and efficiency of the received data. On the other hand, when the mobile communication device and method of one embodiment of the application predicts that Wi-Fi reception and third-party communication will occur simultaneously, a smaller Wi-Fi receive gain is selected. This is to minimize potential issues due to interference, such as an increase in Packet Error Rate. This 3rd party real-time Interference detect mechanism of one embodiment of the application optimizes performance by dynamically adjusting Wi-Fi receive gain, especially in environments where interference may occur. Such dynamic adjustments allow for more flexible responses to different communication environments and conditions, thereby improving the overall communication quality and efficiency.

Still further, one embodiment of the application provides a method for adjusting the Wi-Fi reception gain value in communication scenarios involving Wi-Fi and third party. The aim is to avoid the need to abort communication with either Wi-Fi or the third party, thereby reducing or eliminating the risks. One embodiment of the application may offer a more flexible and efficient way to manage interactions between Wi-Fi and third-party services, thereby improving the overall stability and performance of the system.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for operating a mobile communication device comprising a third party module and a Wi-Fi module, the method comprising:
at a first timing, receiving third party signals via an antenna set of the mobile communication device;
at a second timing, detecting an expected collision between third party communication and Wi-Fi communication, wherein either the third party module or the Wi-Fi module calculates a next Wi-Fi receiving gain and controls the Wi-Fi module to reduce the Wi-Fi receiving gain;
at a third timing, concurrently receiving both the third party signals and the Wi-Fi signals using the reduced Wi-Fi receiving gain; and
at a fourth timing, detecting that the expected collision is expected to disappear, wherein either the third party module or the Wi-Fi module calculates a next Wi-Fi receiving gain that is higher than the reduced Wi-Fi receiving gain, and increases the Wi-Fi receiving gain.

2. The method of claim 1, further comprising estimating, by the third party module or the Wi-Fi module, whether the Wi-Fi reception and the third-party reception occur simultaneously.

3. The method of claim 2, wherein at the second timing, when it is estimated that the Wi-Fi reception and the third-party reception occur simultaneously, the third party module or the Wi-Fi module chooses the next Wi-Fi receiving gain to be lower.

4. The method of claim 2, wherein at the fourth timing, when it is estimated that the Wi-Fi reception and the third-party reception do not occur simultaneously, the third party module or the Wi-Fi module chooses the next Wi-Fi receiving gain to be higher.

5. The method of claim 1, wherein when the third party module expects that the collision between the third party communication and the Wi-Fi communication disappears, the third party module calculates the next Wi-Fi receiving gain and informs and/or controls the Wi-Fi module to increase the Wi-Fi receiving gain.

6. The method of claim 1, wherein when the collision between the third party communication and the Wi-Fi communication is detected or expected by the third party module, the third party module calculates the next Wi-Fi receiving gain, and informs and/or controls the Wi-Fi module to adjust the Wi-Fi receiving gain based on the next Wi-Fi receiving gain to concurrently receive the Wi-Fi signals and the third party signals.

7. The method of claim 1, wherein when the collision between the third party communication and the Wi-Fi communication is detected or expected by the Wi-Fi module, the Wi-Fi module calculates the next Wi-Fi receiving gain to adjust the Wi-Fi receiving gain.

8. The method of claim 1, further comprising:
dynamically adjusting the Wi-Fi receiving gain value to avoid aborting communication with either the Wi-Fi module or the third party module.

9. The method of claim 1, further comprising:
performing a 3rd party real-time interference detection to predict whether the Wi-Fi reception and the third party communication will occur at the same time.

10. The method of claim 9, wherein
the next Wi-Fi receiving gain higher than the Wi-Fi receive gain is selected when the 3rd party real-time interference detection predicts that the Wi-Fi reception and the third party communication will not occur at the same time; and
the next Wi-Fi receiving gain smaller than the Wi-Fi receive gain is selected when the 3rd party real-time interference detection predicts that the Wi-Fi reception and the third party communication will occur simultaneously.

11. A mobile communication device, comprising:
an antenna set for receiving third party signals and Wi-Fi signals;
a third party module coupled to the antenna set, for processing the third party signals; and a Wi-Fi module coupled to the antenna set, for processing the Wi-Fi signals;
wherein:
at a first timing, the antenna set receives the third party signals;
at a second timing, an expected collision between third party communication and Wi-Fi communication is detected, wherein either the third party module or the Wi-Fi module calculates a next Wi-Fi receiving gain and controls the Wi-Fi module to reduce the Wi-Fi receiving gain;
at a third timing, the Wi-Fi module concurrently receives the Wi-Fi signals while the third party module receives the third party signals using the reduced Wi-Fi receiving gain; and
at a fourth timing, when the expected collision is expected to disappear, either the third party module or the Wi-Fi module calculates a next Wi-Fi receiving gain that is higher than the reduced Wi-Fi receiving gain, and increases the Wi-Fi receiving gain.

12. The mobile communication device according to claim 11, wherein either the third party module or the Wi-Fi module estimates whether Wi-Fi reception and third-party reception occur simultaneously.

13. The mobile communication device according to claim 12, wherein at the second timing, when it is estimated that the Wi-Fi reception and the third-party reception occur simultaneously, either the third party module or the Wi-Fi module chooses the next Wi-Fi receiving gain to be lower.

14. The mobile communication device according to claim 12, wherein at the fourth timing, when it is estimated that the Wi-Fi reception and the third-party reception do not occur simultaneously, either the third party module or the Wi-Fi module chooses the next Wi-Fi receiving gain to be higher.

15. The mobile communication device according to claim 11, wherein when the third party module expects that the collision between the third party communication and the Wi-Fi communication disappears, the third party module calculates the next Wi-Fi receiving gain and informs and/or controls the Wi-Fi module to increase the Wi-Fi receiving gain.

16. The mobile communication device according to claim 11, wherein when the collision between the third party communication and the Wi-Fi communication is detected or expected by the third party module, the third party module calculates the next Wi-Fi receiving gain, and informs and/or controls the Wi-Fi module to adjust the Wi-Fi receiving gain based on the next Wi-Fi receiving gain.

17. The mobile communication device according to claim 11, wherein when the collision between the third party communication and the Wi-Fi communication is detected or expected by the Wi-Fi module, the Wi-Fi module calculates the next Wi-Fi receiving gain to adjust the Wi-Fi receiving gain.

18. The mobile communication device according to claim 11, wherein the Wi-Fi module dynamically adjusts the Wi-Fi receiving gain value to avoid aborting communication with either the Wi-Fi module or the third party module.

19. The mobile communication device according to claim 11, wherein either the third party module or the Wi-Fi module performs a 3rd party real-time interference detection to predict whether the Wi-Fi reception and the third party communication will occur at the same time.

20. The mobile communication device according to claim 19, wherein:
the next Wi-Fi receiving gain higher than the Wi-Fi receive gain is selected when the 3rd party real-time interference detection predicts that the Wi-Fi reception and the third party communication will not occur at the same time; and
the next Wi-Fi receiving gain smaller than the Wi-Fi receive gain is selected when the 3rd party real-time interference detection predicts that the Wi-Fi reception and the third party communication will occur simultaneously.
